(19) United States
(12) Patent Application Publication
(10) Pub. No.: US 2018/0118872 A1
(43) Pub. Date: May 3, 2018

(54) INSULATIVE POLYURETHANE RIDGID FOAM BASED ON TDI LIQUID RESIDUE

(71) Applicant: BASF SE, Ludwigshafen am Rhein (DE)

(72) Inventors: Jian Feng XU, Shanghai (CN); Shu Kui WANG, Shanghai (CN)

(21) Appl. No.: 15/565,468

(22) PCT Filed: Mar. 31, 2016
(86) PCT No.: PCT/EP2016/057020

§ 371 Date: Oct. 10, 2017

(30) Foreign Application Priority Data
Apr. 10, 2015 (CN) PCT/CN2015/076302

(51) Int. Cl. C08G 18/40; C08G 18/48; C08G 18/72; C08G 18/76; C08J 9/14

(52) U.S. Cl. CPC C08G 18/4018; C08G 18/4829; C08G 18/727; C08G 2101/0025; C08G 18/7664; C08J 9/144; C08G 18/7621

(57) ABSTRACT

Provided herein is an isocyanate composition which comprises a) TDI liquid residue, and b) other isocyanate component, and relates to reaction formulation for preparing polyurethane which comprises: A) the isocyanate composition of the invention, and B) active hydrogen component. Further provided herein is a polyurethane polymer and a polyurethane polymer foam prepared from the reaction formulation of the invention. Also provided herein is a use of the polyurethane rigid foam of the invention in construction and appliance.

### FIELD OF THE INVENTION

The present invention relates to a polyurethane polymer and an insulative polyurethane rigid foam prepared from the polyurethane polymer. In particular, the present invention relates to a polyurethane polymer prepared from toluene diisocyanate (TDI) liquid residue and an insulative polyurethane rigid foam prepared therefrom.

### BACKGROUND OF THE INVENTION

Insulative polyurethane rigid foam is used in construction, appliance and other applications widely. For example, it is applicable for pipeline, refrigerator, reefer truck, reefer container, Liquefied Natural Gas (LNG) ship, building wall, roof etc. In the field, it is strongly required to improve the thermal insulation performance of the polyurethane rigid foams for various applications that need low thermal-conductivity, and at the same time to lower the related cost.

Generally, ploymethylene diphenyl diisocyanate (PMDI) is mainly used in producing polyurethane rigid foam, because it will achieve good thermal insulation and mechanical physical properties.

It is known to prepare toluene diisocyanate by the phosgenation of toluene diamine. Typical processes for the phosgenation of amines may be found in U.S. Pat. Nos. 2,680,127; 2,822,373 and 3,781,320. In the phosgenation of toluene amines to form toluene diisocyanate, the product diisocyanate is generally distillated from the reaction mixture in which it is prepared. At the conclusion of the distillation, the reaction mixture normally contains a quantity of high boiling residue. Such residue generally comprises polymeric materials such as alpha-, omega-isocyanatobiurets, polycarbodiimides, diisocyanate-carbodiimides, polyuretidinediones, isocyanurates and various other isocyanate adducts. Since this residue is seldom commercially useful, it is usually disposed of.

TDI liquid residue is a common residue obtained from the distillation of the reaction mixture of phosgenation of toluene amines to form toluene diisocyanate. Generally TDI liquid residue contains 30% chemical waste, which needs to spend a lot of money to dispose it. In the recent years, people are searching for a way to reuse TDI liquid residue, as TDI liquid residue is of much lower cost than PMDI. Also, reusing TDI liquid residue which will otherwise be disposed of is an environmental-friendly technical solution.

U.S. Pat. No. 4,904,704 relates to a reaction mixture for preparing polyurethane polymer, which comprises toluene diisocyanate (TDI) Liquid Residue. However, in this reaction mixture, the toluene diisocyanate (TDI) Liquid Residue should be pre-treated before being used. U.S. Pat. No. 3,455,836 and U.S. Pat. No. 3,634,361 discloses new compositions that can be readily prepared by simply blending molten 4,4′-methylene bis (phenylisocyanate) and the viscous toluene diisocyanate residue in any order using conventional blending and metering equipment. The invention is on the basis of the observation that the mixture of the liquid residue and solid 4,4′-methylene bis(phenylisocyanate) results in a liquid composition having a viscosity range considerable below that of the liquid component. The object of U.S. Pat. No. 3,455,836 and U.S. Pat. No. 3,634,361 is to solve the problems of viscosity control and instability of an organic polyisocyanate composition during storage, and to produce an organic polyisocyanate composition having a low viscosity in the range of 35 to 1000 cps at room temperature. However, U.S. Pat. No. 3,455,836 and U.S. Pat. No. 3,634,361 keep silence on the heat-insulation-improving properties of the TDI liquid residue.

In the prior art, there is a need to reuse the toluene diisocyanate (TDI) liquid residue cost-effectively, at the same time provide a polyurethane rigid foam with improved heat-insulating property while keeping excellent physical and mechanical properties.

### SUMMARY

A purpose of the present invention is to provide a composition for producing polyurethane comprising TDI liquid residue.

The present invention is based on a surprising finding that using a mixture of TDI liquid residue and another isocyanate component, especially a mixture of TDI liquid residue and PMDI, will achieve better insulation performance, while keep similar mechanical physical properties to those of the current rigid polyurethane foam.

In the composition of the invention, the TDI liquid residue obtained by distilling toluene diisocyanates from a mixture thereof with by-products obtained in the phosgenation of the corresponding toluenediamines to produce said toluene diisocyanates can be used as such without pretreatment beforehand. The present invention achieves the cost-effective recycling of the TDI liquid residue, and is environment friendly.

The present invention further relates to a polyurethane obtained from the composition of the invention. The polyurethane of the invention may be in form of a rigid foam. The polyurethane rigid foam of the invention will have improved heat-insulating property while keeping excellent physical and mechanical properties.

### DETAILED DESCRIPTION OF THE INVENTION

Unless defined otherwise, all technical and scientific terms used herein have the same meaning as commonly understood by one of ordinary skill in the art to which this invention belongs.

Expressions “a”, “an”, “the”, when used to define a term, include both the plural and singular forms of the term.

The term “polymer”, as used herein, includes both homopolymers, that is, polymers prepared from a single reactive compound, and copolymers, that is, polymers prepared by reaction of at least two polymer forming reactive, monomeric compounds.

In a first aspect, the present invention relates to an isocyanate composition, comprising

a). TDI liquid residue, and

b). other isocyanate component

wherein the amount of TDI liquid residue in the isocyanate composition is at least 3% by weight, preferably at least 5% by weight, more preferably at least 6% by weight, most preferably at least 8% by weight, and up to 18% by weight, preferably up to 16% by weight, more preferably up to 15% by weight, most preferably up to 12% by weight, based on the total weight of the isocyanate composition.

In a preferable embodiment, the isocyanate composition of the invention comprises 8% by weight to 18% by weight of TDI liquid residue, based on the total weight of the isocyanate composition.

TDI liquid residue from the distillation of any toluene diisocyanate production is suitably used in accordance with the present invention. The TDI liquid residue, also defined as TDI liquid distillation residue, employable herein is advantageously formed in the phosgenation of toluene diamine to form a toluene diisocyanate. After phosgenation, the product diisocyanate is removed from the reaction mixture by distillation. The TDI liquid residue is that portion of the reaction mixture which remains following the removal of a part of the product diisocyanate. The TDI liquid residue employable herein preferably contains a quantity of the diisocyanate such that the TDI liquid residue is generally a liquid at the temperatures as which it is produced.

The phosgenation of the toluenediamine can be performed in any way known in the art. This includes phosgenation in liquid phase, using a solvent, as well as phosgenation in gas phase at temperatures of about 300° C. To produce the TDI liquid residue according to the invention in a preferred embodiment the phosgenation is performed in liquid phase. For such a liquid phase phosgenation in one embodiment Toluenediamine and phosgene are reacted at temperatures of preferably 0-50° C. in a solvent such as o-dichlorobenzene to give a mixture of carbamyl chlorides and amine hydrochlorides. The reaction product is then fed into the hot phosgenation tower where, at temperatures of preferably more than 100° C., more preferably 170-185° C., it is reacted further with phosgene to form the diisocyanates. The excess phosgene can be separated from HCl in a deep freezing unit and is then recycled to the process.

In another preferred process, the toluenediamines are dissolved in an inert solvent, such as o-diehlorobenzene, and are converted into a salt suspension by injecting dry HCl. Phosgene is reacted with the hydrochlorides at elevated temperatures and with strong agitation to give the diisocyanates. The HCl, which evolves, is removed with an inert gas stream.

The Toluenediamine required for such a process can be obtained in known ways such as nitration of toluene using nitrating acid followed by catalytic hydrogenation for example in methanol with Raney nickel, usually resulting in 2,4- and 2,6 dinitrotoluene in a ratio of 70:30 to 90 to 10, preferably roughly 80:20. In a preferred embodiment the contend of ortho-TDA is less then 2% by weight, more preferred less than 1% by weight and most preferred less than 0.5% by weight of the total weight of TDA.

The TDI liquid residue referred to herein advantageously contains from about 50 to about 90, preferably from about 55 to about 85, more preferably from about 60 to about 80 by weight percent free toluene diisocyanate. The TDI liquid residue generally has an isocyanate group (NCO) content from 22 to about 45, preferably from about 30 to about 40 percent by weight and is substantially free of solvent. The viscosity of the TDI liquid residue is in the range of equal to or greater than 100 cps @25° C., for example equal to or greater than 500 cps @25° C., preferably equal to or greater than 800 cps @25° C., more preferably equal to or greater than 1200 cps @25° C., most preferably equal to or greater than 1500 cps @25° C., and equal to or less than 5000 cps @25° C., preferably equal to or less than 4000 cps @25° C., more preferably equal to or less than 3500 cps @25° C., most preferably equal to or less than 3000 cps @25° C. If the viscosity <100, the physical properties of the rigid foam will be bad, If >5000, the processing performance will be bad.

The chemical composition of the TDI liquid residue is not certain, but the residue generally comprises mixtures of materials such as polyureas, (poly)biurets, alpha, omega-isocyanato-biurets, polycarbodiimides, polyuretdiones, isocyanurates, diisocyanatocarbodiimides, addition products of monomeric diisocyanates and carbodiimides, isocyanurates, polyisocyanates that have polyuretidinedione groups and the like. Such materials usually contain free or capped isocyanate groups.

Any polyisocyanate can be used as component b) of the isocyanate composition of the invention, provided that it can be used for preparing polyurethane, especially for preparing polyurethane rigid foam. Exemplary suitable polyisocyanates include aromatic, aliphatic and cycloaliphatic polyisocyanates and combinations thereof. Representative polyisocyanates includes diisocyanates such as m-phenylene diisocyanate, toluene-2,4-diisocyanate, toluene-2,6-diisocyanate, hexamethylene-diisocyanate, tetramethylene-diisocyanate, cyclohexane-1,4-diisocyanate, hexahydrotoluene diisocyanate (and isomers thereof), 1-methoxyphenyl-2,4-diisocyanate, diphenylmethane-4,4′-diisocyanate, diphenylmethane-2,4′-diisocyanate, 3,3′-dimethyl-4,4′-biphenyl diisocyanate, 3,3′-dimethyldiphenyl-methane-4,4′-diisocyanate and the like; triisocyanates such as 4,4′,4″-triphenylmethane triisocyanate, toluene-2,4,6-triisocyanate, and the like; tetraisocyanates such as 4,4′-dimethyldiphenyl-methane-2,2′,5,5′-tetraisocyanate, 4,4′-dicyclohexane-diisocyanate, isophorone diisocyanate, isomers of each and the like; as well as other polyisocyanates such as polyphenylisocyanate and the like and mixtures thereof. Toluene diisocyanate, diphenylmethane-4,4′-diisocyanate, diphenylmethane-2,4′-diisocyanate and polymethylene polyphenylisocyanate are beneficial for use in the practice of the invention because of their availability and properties. Mixtures of polyisocyanate components are also suitably used as component b) in the practice of the invention.

Polymethylene polyphenylpolyisocyanates, also referred to as or polymeric methylene diphenylisocyanates or PMDI, is more preferred for use in the practice of the invention. Polymethylene polyphenylpolyisocyanates are well known isocyanates and comprise mixtures of monomeric diphenylmethanediisocyanates as diphenylmethane-4,4′-diisocyanate and diphenylmethane-2,4′-diisocyanate, and higher homologs of Diphenylmethandiisocyanate having 3 or more aromatic rings, each ring carrying one isocyanate group. Polymeric methylene diphenylisocyanate is commercially prepared by phosgenation of mixtures of the corresponding methylene-bridged polyphenyl polyamines. The latter, in turn, are obtained by interaction of formaldehyde, hydrochloric acid and primary aromatic amines such as aniline, o-chloroaniline, o-toluidine, and the like using procedures well known in the art. Illustrative of known methods for preparing methylene-bridged polyphenyl polyamines and polymethylene polyphenylisocyanates therefrom are those described in U.S. Pat. Nos. 2,683,730; 2,950,263; 3,012,008; 3,344,162 and 3,362,979; Canadian Pat. No. 700,026 and German specification 1,131,877 (all herein incorporated by reference in entirety).

Without being intended to be bound to any theory, it is surprising found that in the isocyanate composition of the present invention wherein component b) is selected from polymethylene polyphenylisocyanates, or polymeric methylene diphenylisocyanates, not only the TDI liquid residue can be used as such, without the need of further processing, but also the polyurethane rigid foams obtained therefrom have improved heat-insulating property as compared with polyurethane rigid foams prepared from merely polymethylene polyphenylisocyanates or polymeric methylene diphenylisocyanates, at the same time keep excellent physical and mechanical properties.

In a preferred embodiment of the invention, the isocyanate composition of the invention comprises, as the component a), the TDI liquid residue, and as the component b), ploymethylene diphenyl diisocyanate (PMDI). Suitable ploymethylene diphenyl diisocyanate is, such as, Lupranate M20S, commercially available from Shanghai BASF Polyurethane Co., Ltd, Shanghai, China.

In a preferred embodiment of the invention, the isocyanate composition of the invention comprises 8% by weight to 18% by weight of TDI liquid residue, and 82% by weight to 92% by weight of PMDI, based on the total weight of the isocyanate composition.

In a second aspect of the invention, the present invention relates to a reaction formulation for preparing polyurethane, comprising:

A) the isocyanate composition of the invention, and

B) active hydrogen component.

The component A may be used in any amount in the reaction formulation of the invention, provided that it can form polyurethane, especially a polyurethane rigid foam.

Polyurethane rigid foams are well known. The rigid polyurethane foams of the invention typically have a compressive stress at 10% compression that is greater than or equal to 80 kPa, preferably greater than or equal to 120 kPa, particularly preferably greater than or equal to 150 kPa. The rigid polyurethane foam moreover has a closed-cell factor of more than 80% in accordance with DIN ISO 4590, preferably more than 90%. Further details concerning rigid polyurethane foams of the invention are found in “Polyurethane Handbook, Carl Hanser Gardener Publications, 2nd edition, 1993, chapter 6. The density of rigid polyurethane foams usually is in the range of 15 to 300 g/dm³, preferably 20 to 200 g/dm³, more preferably 25 to 100 g/dm³ and most preferably 30 to 70 g/dm³.

Rigid foams according to the present invention show good thermal insulation properties and at the same time good mechanical properties and therefore can be used in all common applications for rigid polyurethane foams. In a preferred embodiment, the rigid polyurethane foams are used in the field of insulation as insulation of refrigerators and freezers, insulation in the construction industry as insulation of commercial and residential buildings, and industrial insulation as insulation of tanks, pipes and in ship building. In the present invention the application of polyurethane rigid foams in the field of insulation is also referred to as the application of polyurethane rigid foam in the field of appliance. The field of insulation is also Due to the good mechanical properties of the polyurethane rigid foams according to the invention especially insulation applications are preferred wherein the polyurethane foam is required to have a high mechanical strength. Such applications are for example pipe insulations, especially for subterrain pipes or tank insulations. Especially in the field of tank insulation a high pressure can be applied to the insulation simply by the weight of the filled tank. This is especially a problem in the field of LNG carriers. Here the insulation has to withstand also to forces generated by the movement of the ship, for example in rough sea. Therefore, the polyurethane according to the present invention is preferably used for the insulation of LNG tanks on board of ships, especially on board of LNG carriers.

The production of polyurethane rigid foam for such special applications is well known. Surprisingly, the rigid polyurethane foams according to the invention can be produced by simply replacing at least 3% by weight and up to 18% by weight, preferably 5% to 16% by weight, more preferred 6% to 15% by weight and most preferred 8% to 12% by weight of the isocyanate composition by the TDI liquid residue while the other ingredients as well as the processing can remain unchanged.

Active hydrogen components are compounds having hydrogen-containing functional groups which will react with an isocyanate group. Suitable active hydrogen components are those conventionally employed in the preparation of polyurethanes such as the compounds described in U.S. Pat. No. 4,394,491, particularly in columns 3 through 5 thereof, wherein the compounds are called polyahls, which patent is incorporated herein by reference in its entirety. Suitable active hydrogen components are generally liquids or solids capable of being melted at relatively low temperatures.

Active hydrogen components most commonly used in polyurethane production are those compounds having at least two hydroxyl groups, which compounds are referred to as polyols. Typical polyols include polyester polyols, polyester amide polyols, and polyether polyols, having at least two hydroxyl groups. Polyethers and polyesters having hydroxyl terminated chains are preferred for use as the active hydrogen components in the reaction formulation of the invention. Examples of polyols also include hydroxy functional acrylic polymers, hydroxyl-containing epoxy resins, polyhydroxy terminated polyurethane polymers, polyhydroxyl-containing phosphorus compounds and alkylene oxide adducts of polyhydric thioethers, including polythioethers, acetals, including polyacetals.

Polyether polyols advantageously employed in the practice of this invention are polyalkylene polyether polyols including the polymerization products of oxiranes or other oxygen-containing heterocyclic compounds such as tetramethylene oxide in the presence of such catalysts as boron trifluoride potassium hydroxide, triethylamine, tributyl amine and the like, or initiated by water, polyhydric alcohols having from about two to about eight hydroxyl groups, amines and the like. Illustrative alcohols suitable for initiating formation of a polyalkylene polyether polyols include ethylene glycol, 1,3-propylene glycol, 1,2-propylene glycol, 1,4-butylene glycol, 1,3-butylene glycol, 1,2-butylene glycol, 1,5-pentane diol, 1,7-heptane diol, glycerol, 1,1,1-trimethylolpropane, 1,1,1-trimethylolethane, hexane-1,2,6-triol, alpha-methyl glucoside, pentaerythritol, erythritol, pentatols and hexatols. Sugars such as glucose, sucrose, fructose, maltose and the like as well as compounds derived from phenols such as (4,4′-hydroxyphenyl)2,2-propane, and the like are also suitable polyhydric alcohols for forming polyether polyols useful in the practice of the invention.

If polyols are used as active hydrogen components to form the reaction formulation of the invention for preparing a polyurethane rigid foam, the polyols may be of any appropriate functionality. Preferably the functionality of the polyols is in the range of 2-8, more preferably 3-7 and most preferably 3-6; and preferably the weight average molecular weight of the polyols is in the range of 50-3000, preferably 100-2500, more preferably 200-2000 and most preferably 300-1500. Molecular weight of the polyols in the polyurethane field is generally determined by end group analysis as the determination of the hydroxyl number. Therefore the average molecular weight of the polyols is given as number average molecular weight. The component B) may be used in any amount in the reaction formulation of the invention, provided that it can form polyurethane with component A).

Polyols or other active hydrogen components B) are preferably reacted with the component A) in amounts sufficient to achieve an isocyanate index appropriately from 60 to about 500, such as about 60 to about 150, preferably from about 90 to about 125, more preferably from about 100 to about 120. The isocyanate index is the ratio of [the mole number of isocyanate group (NCO group) in the component A)])/[the mole number of active hydrogen group comprised in the reaction formulation]×100.

The isocyanate composition of the invention is advantageously reacted with the active hydrogen component B) in the presence of blowing agents. The reaction formulation of the invention may comprise, as component C), a blowing agent. The component C) may be used in any amount in the reaction formulation of the invention, provided that it can form a polyurethane rigid foam. Preferably the component C) may be used in an amount of 1-35% by weight, more preferable the component C) may be used in an amount of 1-30% by weight, based on the total weight of the reaction formulation of the invention.

Any blowing agent or mixture thereof is suitable for use in the practice of the invention, provided that it can be used for preparing a polyurethane rigid foam. Suitable blowing agents include various chemical blowing agents and physical blowing agents, such as water, dissolved inert gases; acetone; ethyl acetate; methanol; ethanol; halogen substituted alkanes such as methylene chloride, chloroform, ethylidene chloride, vinylidene chloride, monofluorotrichloromethane, monofluorodichloroethane, chlorodifluoromethane, dichlorodifluoromethane and the like; butane; hexane; heptane; diethyl ether; and the like. Gases inert to the starting components such as nitrogen, air, carbon dioxide and the like are also useful blowing agents. Compounds such as azides which decompose at temperatures present in the mold to produce gases such as nitrogen are also useful. Preferred blowing agents are compounds which boil between about −50° C. and 100° C., more preferably between about 0° C. and 50° C.

One or more catalysts may be used in the reaction formulation of the invention as component D) to make polyurethane. Any catalyst applicable for the preparation of polyurethane in the art may be suitable for the present invention. Suitable catalysts for preparation of polyurethane foams are any which catalyze reactions of isocyanates with active hydrogen groups of the active hydrogen compounds. Such catalysts are referred to herein as polyurethane catalysts. For example, the catalysts applicable for the present invention comprise, but is not limited to, amine catalysts, organic metallic catalysts, or mixtures thereof. Suitable amine catalysts include tertiary amines, such as, triethylenediamine, N-methyl morpholine, N-ethyl morpholine, diethyl ethanolamine, 1-methyl-4-dimethylaminoethyl piperazine, 3-ethoxy-N-dimethylpropylamine, N,N-dimethyl-N′,N′-methyl isopropyl propylene diamine, N,N-diethyl-3-diethylaminopropylamine, dimethyl benzylamine, triethylamine, tributylamine, bis(N,N-diethylaminoethyl)adipate, 2-methylimidazole, 1,4-diaza-bicyclo(2,2,2)-octane, dimethyl cyclohexylamine, and the like. Other suitable catalysts comprise organic alkali metal compounds, such as potassium acetate; and tin compounds, such as stannous chloride, tin salts of carboxylic acids such as dibutyltin di-2-ethyl hexoate, dibutyl tin dilaurate, dibutyltin diacetate, di-2-ethylhexyltin oxide, stannous octoate and the like, as well as other organometallic compounds such as compounds of iron, lead, arsenic, antimony, mercury and bismuth.

Generally, the component D) may be used in any amount in the reaction formulation of the invention, provided that it is suitable for forming a polyurethane polymer. Preferably the component D) may be used in an amount of 0.1-5% by weight, more preferable the component D) may be used in an amount of 0.1-3% by weight, based on the total weight of the reaction formulation of the invention.

The reaction formulation of the invention may further comprises, as component E), a foam stabilizer. Suitable foam stabilizers are generally wetting agents or surfactants. Nonionic surfactants and wetting agents are generally preferred, such as silicon-based surfactants. Such foam stabilizers are generally commercially available with specific instructions as to their use. The component E) may be used in any appropriate amount in the reaction formulation of the invention. Preferably the component E) may be used in an amount of 1-5% by weight, more preferable the component E) may be used in an amount of 1-4% by weight, most preferable the component E) may be used in an amount of 1-3% by weight, based on the total weight of the reaction formulation of the invention.

In a third aspect, the present invention relates to a polyurethane polymer prepared from the reaction formulation of the invention.

In a fourth aspect, the present invention relates to a polyurethane rigid foam prepared from the reaction formulation of the invention, wherein the reaction formulation of the invention further comprising component C), a blowing agent.

Any effective method is suitably used to prepare the polyurethane polymer, especially the polyurethane rigid foam of the invention. These methods are well known in the art. For example, an exemplary method may be the one wherein the isocyanate composition, and the mixture of active hydrogen component, catalyst, blowing agent, and foam stabilizer and the like are prepared separately, then the isocyanate composition and the mixture are metered and mixed together for chemical reaction to form a polyurethane rigid foam. Further methods and applicable apparatus may be found in “Polyurethane Foam Plastics”, Lvmin ZHU, et., al, Chemical Industry Press (CIP), China, the third Edition, p 408 (herein incorporated by reference in entirety). In preparing the polyurethane polymer, the isocyanate composition of the invention are reacted with the active hydrogen component preferably in the presence of a catalyst which catalyzes the formation of polyurethane bonds and preferably in the presence of a blowing agent suitable for forming foams having preselected physical properties. Additives such as surface active agents, antistatic agents, plasticizers, fillers, flame retardants, pigments, stabilizers such as antioxidants, fungistatic and baceriostatic substances and the like are optionally used in polyurethane rigid foams of the invention. Selection and use of such compounds is within the skill in the art.

In addition, the present invention relates to use of the polyurethane rigid foam of the invention, such as to use of the polyurethane rigid foam of the invention in construction, appliance.

To sum up, the present invention includes the following embodiments.
1. an isocyanate composition, comprising
a) TDI liquid residue, and
b) other isocyanate component,

Wherein the amount of TDI liquid residue in the isocyanate composition is at least 3% by weight, preferably at least 5% by weight, more preferably at least 6% by weight, most preferably at least 8% by weight, and up to 18% by weight, preferably up to 16% by weight, more preferably up to 15% by weight, most preferably up to 12% by weight, based on the total weight of the isocyanate composition.

2. the isocyanate composition of embodiment 1, wherein the amount of TDI liquid residue in the isocyanate composition is in the range of from 8% by weight to 18% by weight, based on the total weight of the isocyanate composition.

3. the isocyanate composition of any one of embodiments 1-2, wherein the TDI liquid residue contains from about 50 to about 90, preferably from about 55 to about 85, more preferably from about 60 to about 80 by weight percent free toluene diisocyanate.

4. the isocyanate composition of any one of embodiments 1-3, wherein the TDI liquid residue has viscosity in the range of equal to or greater than 500 cps @25° C., preferably equal to or greater than 800 cps @25° C., more preferably equal to or greater than 1200 cps @25° C., most preferably equal to or greater than 1500 cps @25° C., and equal to or less than 5000 cps @25° C., preferably equal to or less than 4000 cps @25° C., more preferably equal to or less than 3500 cps @25° C., most preferably equal to or less than 3000 cps @25° C.

5. the isocyanate composition of any one of embodiments 1-4, wherein component b) of the isocyanate composition is selected from the group consisting of aromatic, aliphatic and cycloaliphatic polyisocyanates, preferably component b) of the isocyanate composition is selected from the group consisting of polymethylene polyphenylisocyanates, polymeric methylene diphenylisocyanates, and combination thereof, more preferably component b) of the isocyanate composition is selected from the group consisting of polymethylene diphenyldiisocyanates.

6. a reaction formulation for preparing polyurethane, comprising:
A) the isocyanate composition of any one of embodiments 1-5, and
B) active hydrogen component.

7. the reaction formulation of embodiment 6, wherein the component B is polyols.

8. the reaction formulation of embodiment 7, wherein the functionality of the polyols is in the range of preferably 2-8, more preferably 3-7 and most preferably 3-6.

9. the reaction formulation of embodiment 7 or 8, wherein the weight average molecular weight of the polyols is in the range of 50-3000, preferably 100-2500, more preferably 500-2000 and most preferably 600-1500.

10. the reaction formulation of any one of embodiments 6-9, wherein a isocyanate index of the reaction formulation is in the range of from about 60 to about 150, preferably from about 90 to about 125, more preferably from about 100 to about 120, wherein the isocyanate index is the ratio of [the mole number of isocyanate group (NCO group) in the component A)])/[the mole number of active hydrogen group comprised in the reaction formulation]×100.

11. the reaction formulation of any one of embodiments 6-10, wherein it further comprises a blowing agent.

12. the reaction formulation of any one of embodiments 6-11, wherein it further comprises one or more catalysts to make polyurethane.

13. The reaction formulation of any one of embodiments 6-12, wherein it further comprises a foam stabilizer.

14. a polyurethane polymer prepared from the reaction formulation of anyone of embodiments 6-13.

15. a polyurethane rigid foam prepared from the reaction formulation of anyone of embodiments 6-13, wherein the reaction formulation further comprises a blowing agent.

16. Use of the polyurethane rigid foam of embodiment 15 in construction and appliance.

### Advantages of the Invention

The present invention has the following advantages:
1. The present invention makes use of the TDI liquid residue which otherwise will be disposed of, thus is environmentally friendly.
2. The TDI liquid residue will be used as such, without the need of pretreatment, thus it is cost effective.
3. the polyurethane rigid foam obtained from the composition of the present invention achieves better insulation performance than the current rigid polyurethane foam, while keep similar mechanical and physical properties to it.

### EXAMPLES

The present invention will be further illustrated hereinafter with the reference of the specific examples which are exemplary and explanatory only and are not restrictive.

Each part and percentage when used, if not defined otherwise, is provided on weight basis. Materials and apparatus that were used:

| Material | Trade name | Supplier | Ingredient |
|---|---|---|---|
| PS3152 | PS3152 | Stepan Company, | Polyester polyol; |
| | | Illinois, USA | hydroxyl value 321, |
| | | | functionality = 2, Mn = |
| | | | 350 |
| GR8348 | GR8348 | Shanghai Gaoqiao | Polyether polyol; |
| | | Petroleum Chemical | hydroxyl value 480, |
| | | Company, Shanghai | functionality 4.5, |
| | | China | Mn = 520 |
| TCPP | TCPP | Jiangsu Yoke | Tri(2- |
| | | Technology Co., Ltd., | chloropropyl)phosphate, |
| | | Jiangsu, China | as flame retardant |
| L6900 | Niax silicone | Momentive | Polyether modified |
| | L6900 | Performance | Polysiloxane |
| | | Materials Inc., New | |
| | | York, U.S.A | |
| PC46 | Polycat 46 | Air Products & | Potassium acetate |
| | | Chemicals, Penna., | |
| | | U.S.A | |
| PC-8 | Polycat 8 | Air Products & | Dimethyl |
| | | Chemicals, Penna., | cyclohexylamine |
| | | U.S.A | |
| water | — | — | — |
| 141b | HCFC141b | Zhejiang Sanmei | CH₃CCl₂F |
| | | Chemical Industry | |
| | | Co., Ltd., | |
| | | Zhejiang, China | |
| M20S | Lupranate | Shanghai BASF | ploymethylene diphenyl |
| | M20S | Polyurethane Co., Ltd, | diisocyanate, |
| | | Shanghai, China | functionality 2.7 |
| TDI | Lupranate | Shanghai BASF | Toluene diisocyanate |
| | T80 | Polyurethane Co., Ltd, | |
| | | Shanghai, China | |

The TDI liquid residue used in the examples was obtained directly from distillation of the reaction mixture of phosgenation of toluene amines to form toluene diisocyanate in Shanghai BASF Polyurethane Co., Ltd, Shanghai, China, without further pretreatment.

The TDI liquid residue contained 70% free TDI. The remainings were oligomers including urea, diuret, trimer, etc. The free NCO content was 37%.

In following examples, the inventive compositions and formulations are numbered by arabic numeral.

The comparative compositions and formulations are numbered by capital letter. Abbreviations:

“RF” means Reaction formulation.

“Com 1” to “Com 3” correspond to above inventive composition 1 to inventive composition 3 respectively, and

“Com A” to “Com C” correspond to above comparative composition A to comparative composition C respectively.

“Foam 1” to “foam 3” correspond to foams obtained from inventive reaction formulation 1 to inventive reaction formulation 3 respectively, and

“Foam A” to “foam C” correspond to foams obtained from comparative reaction formulation 1 to comparative reaction formulation 3 respectively.

### Example 1. Preparation of the Isocyanate Composition

According to the composition showing in the table 1, several isocyanate compositions were prepared. The amount of each component was provided in parts by weight. For each composition, ingredients listed in table 1 with the specified amount thereof in table 1 were charged into a vessel and were stirred with Pendraulik LD 50 Mixer (commercial available from Pendraulik Maschinen and Apparate GmbH, NI, Germany) at 1800 RPM for 3-5 min, to obtain the intended composition.

TABLE 1

| | M20S | TDI liquid residue | TDI |
|---|---|---|---|
| Inventive composition 1 | 92 | 8 | 0 |
| Inventive composition 2 | 87 | 13 | 0 |
| Inventive composition 3 | 82 | 18 | 0 |
| Comparative composition A | 75 | 25 | 0 |
| Comparative composition B | 50 | 0 | 35 |
| Comparative composition C | 100 | 0 | 0 |

### Example 2. Preparation of the Polyurethane Rigid Foam

### 1. Polyurethane Rigid Foam 1

PS3152, GR8348, TCPP, L6900, PC46, PC-8, water and 141b listed in column “RF 1” of table 2 with the specified amount thereof were charged into a vessel and were stirred with Pendraulik LD 50 Mixer at 1800 RPM for 3-5 min to form mixture 1.

117.1 parts by weight of above prepared inventive composition 1, and the whole above prepared mixture 1 were mixed in a vessel and stirred with Pendraulik LD 50 Mixer at 1800 RPM for 5-8 seconds to form reaction formulation preparation 1.

Then the formed reaction formulation preparation 1 was poured into a mold of 40*40*10 cm, and was set for 8 min to form polyurethane rigid foam 1 (foam 1). The mold temperature is 45° C. Then the obtained foam 1 was removed from the mold.

### 2. Other Polyurethane Rigid Foams

Other foams listed in table 3 were prepared by the same procedure as the one for preparing above Polyurethane Rigid Foam 1, except that the ingredients and amount thereof were provided according to table 2.

Reaction formulations of the polyurethane rigid foams are listed in following table 2. The amount of each component was provided in parts by weight.

For all the reaction formulation in table 2, the isocyanate index is 114.5.

TABLE 2

| | RF 1 | RF 2 | RF 3 | RF A | RF B | RF C |
|---|---|---|---|---|---|---|
| Com 1 | 117.1 | | | | | |
| Com 2 | | 116.0 | | | | |
| Com 3 | | | 115.3 | | | |
| Com A | | | | 113.6 | | |
| Com B | | | | | 97.0 | |
| Com C | | | | | | 119.0 |
| PS3152 | 20 | 20 | 20 | 20 | 20 | 20 |
| GR8348 | 55 | 55 | 55 | 55 | 55 | 55 |
| TCPP | 20 | 20 | 20 | 20 | 20 | 20 |
| L6900 | 1.7 | 1.7 | 1.7 | 1.7 | 1.7 | 1.7 |
| PC46 | 0.3 | 0.3 | 0.3 | 0.3 | 0.3 | 0.3 |
| PC-8 | 1.0 | 1.0 | 1.0 | 1.0 | 1.0 | 1.0 |
| water | 1.7 | 1.7 | 1.7 | 1.7 | 1.7 | 1.7 |
| 141b | 12.0 | 12.0 | 12.0 | 12.0 | 12.0 | 12.0 |

### Example 3. Properties Test of the Polyurethane Rigid Foam

Polyurethane rigid foam obtained from each reaction formulation was tested for Core Density, K-factor @ 15/31° C. (mW/m*K), Compressive strength (N/mm³), and Dimensional stability (−30° C./24 h).

### 1. Core Density

A sample of obtained foam was tested for core density after the dense skin was removed. The obtained result was provided in kg/m³.

### 2. K-factor

K-factor was tested in instrument EKO HC-074/200 (commercial available from LaserComp, Inc., Massachusetts, U.S.A.) according to the operation instruction, wherein the upper plate is set to 15° C., and the lower plate is set to 31° C.

### 3. Compressive Strength

Compressive strength was tested according to standard method DIN EN 826.

### 4. Dimensional Stability

A foam sample having initial length, width, and height sizes was placed at −30° C. for 24 hours, then the change of each size was measured. The percentage of the change is reported in table 3.

The results of the test are reported in table 3.

TABLE 3

| | Core | K-factor | | |
|---|---|---|---|---|
| | Density | @15/31° C. | Compressive | Dimensional |
| | kg/m³ | (mW/m * K) | strength, N/mm³ | stability, L/W/H |
| Foam 1 | 35.2 | 23.10 | 0.24 | 0/0.3/0.1 |
| Foam 2 | 35.2 | 23.05 | 0.25 | 0/0.3/0.2 |
| Foam 3 | 35.0 | 22.95 | 0.23 | 0/0.2/0 |
| Foam A | 34.1 | 22.90 | 0.19 | 0.7/0.5/0.6 |
| Foam B | 32.8 | 22.74 | 0.14 | 0.8/0.3/0.1 |
| Foam C | 36.0 | 23.53 | 0.24 | 0/0.2/0.1 |

Abbreviations:
L/W/H means the percentage of the change in length/the percentage of the change in width/the percentage of the change in height.

As can be seen from table 3, compared with foam A and foam B, the Dimensional stability and Compressive strength of the inventive foams are greatly improved. Compared with foam C, K-factors of inventive foams are improved.

With the isocyanate composition of the present invention, the obtained polyurethane rigid foams have improved heat-insulating property as compared with foam C while keeping excellent physical and mechanical properties.

Each of the documents referred to above is incorporated herein by reference.

Except in the Examples, or where otherwise explicitly indicated, all numerical quantities in this description specifying amounts of materials, reaction conditions, molecular weights, number of carbon atoms, and the like, are to be understood as modified by the word “about”.

It is to be understood that the upper and lower amount, range, and ratio limits set forth herein may be independently combined. Similarly, the ranges and amounts for each element of the invention can be used together with ranges or amounts for any of the other elements.

The present invention is not to be limited in scope by the specific embodiments and examples described herein. Indeed, various modifications of the invention in addition to those described herein will become apparent to those skilled in the art from the foregoing description. Such modifications are intended to fall within the scope of the appended claims.

1. An insulation of at least one of subterrain pipes and LNG tanks comprising:
a rigid polyurethane foam prepared from a reaction formulation comprising:
A) an isocyanate composition comprising:
a) TDI liquid residue, and
b) other isocyanate component,
wherein an amount of TDI liquid residue in the isocyanate composition is at least 3% by weight and up to 18% by weight, based on a total weight of the isocyanate composition, and
wherein the other isocyanate component of the isocyanate composition is selected from the group consisting of aromatic, aliphatic, and cycloaliphatic polyisocyanates,
B) active hydrogen component; and
C) blowing agent.

2. The insulation of at least one of subterrain pipes and LNG tanks of claim 1, wherein the amount of TDI liquid residue in the isocyanate composition is in a range from 8% by weight to 18% by weight, based on the total weight of the isocyanate composition.

3. The insulation of at least one of subterrain pipes and LNG tanks of claim 1, wherein the TDI liquid residue contains from 50 to 90 by weight percent free toluene diisocyanate.

4. The insulation of at least one of subterrain pipes and LNG tanks of claim 1, wherein the TDI liquid residue has viscosity equal to or greater than 500 cps at 25° C. and equal to or less than 5000 cps at 25° C.

5. The insulation of at least one of subterrain pipes and LNG tanks of claim 1, wherein the other isocyanate component is selected from the group consisting of polymethylene diphenyldiisocyanates.

6. The insulation of at least one of subterrain pipes and LNG tanks of claim 1, wherein the active hydrogen component is one or more polyols.

7. The insulation of at least one of subterrain pipes and LNG tanks of claim 6, wherein a functionality of the one or more polyols is in a range of 2-8.

8. The insulation of at least one of subterrain pipes and LNG tanks of claim 6, wherein a weight average molecular weight of the one or more polyols is in a range of 50-3000.

9. The insulation of at least one of subterrain pipes and LNG tanks of claim 1, wherein an isocyanate index of the reaction formulation is in a range of from 60 to 150 wherein the isocyanate index is a ratio of [a mole number of isocyanate group (NCO group) in the isocyanate composition)]/[a mole number of the active hydrogen component]×100.

10. (canceled)

11. The insulation of at least one of subterrain pipes and LNG tanks of claim 1, wherein the reaction formulation further comprises one or more catalysts to make polyurethane.

12. The insulation of at least one of subterrain pipes and LNG tanks of claim 1, wherein the reaction formulation further comprises a foam stabilizer.

13. (canceled)

14. The insulation of at least one of subterrain pipes and LNG tanks of claim 1, wherein the other isocyanate component of the isocyanate composition is selected from the group consisting of diphenylmethane-4,4′-diisocyanate, diphenylmethane-2,4′-diisocyanate, higher homologs of Diphenylmethandiisocyanate, and combinations thereof.

15. The insulation of at least one of subterrain pipes and LNG tanks of claim 1, wherein the TDI liquid residue contains from 55 to 85 by weight percent free toluene diisocyanate.

16. The insulation of at least one of subterrain pipes and LNG tanks of claim 1, wherein the TDI liquid residue has viscosity equal to or greater than 800 cps at 25° C. and equal to or less than 4000 cps at 25° C.

18. The insulation of at least one of subterrain pipes and LNG tanks of claim 6, wherein a functionality of the one or more polyols is in a range of 3-7.

19. The insulation of at least one of subterrain pipes and LNG tanks of claim 6, wherein a weight average molecular weight of the one or more polyols is in a range of 100-2500.

20. The insulation of at least one of subterrain pipes and LNG tanks of claim 1, wherein an isocyanate index of the reaction formulation is in a range of from 90 to 125, wherein the isocyanate index is a ratio of [a mole number of isocyanate group (NCO group) in the isocyanate composition])/[a mole number of the active hydrogen component]×100.
